(19) United States
(12) Patent Application Publication
(10) Pub. No.: US 2008/0297786 A1
(43) Pub. Date: Dec. 4, 2008

(54) INSPECTING DEVICE AND INSPECTING METHOD

(75) Inventors: Hideki Fukushima, Higashichichibu (JP); Minori Noguchi, Joso (JP); Shuichi Chikamatsu, Konosu (JP)

Correspondence Address: MCDERMOTT WILL & EMERY LLP, 600 13TH STREET, N.W., WASHINGTON, DC, 20005-3096, US

(73) Assignee: HITACHI HIGH-TECHNOLOGIES CORPORATION

(21) Appl. No.: 12/130,597

(22) Filed: May 30, 2008

(30) Foreign Application Priority Data
May 31, 2007 (JP) 2007-145392
Feb. 27, 2008 (JP) 2008-046167

(51) Int. Cl. G01N 21/01

(52) U.S. Cl. 356/244

(57) ABSTRACT

An object of the invention is to provide an inspecting method and an inspecting device which can detect a foreign material and a pattern defect at a high speed and a high precision, and can suppress a cost increase, by correcting a photographed image of an inspected subject and regulating a direction of an image sensor photographing the inspected subject without depending only upon a positional displacement correcting control of a stage. In an inspecting method of inspecting an inspected subject mounted on a moving stage by photographing by an image sensor, the method determines a positional displacement amount between a target position and an actual position of the stage which moves for photographing, and carries out a sampling position correction in correspondence to the positional displacement amount, on the basis of a photographed image sampling from a photographed range of the target position which is photographed.

### BACKGROUND OF THE INVENTION

(1) Field of the Invention

The present invention relates to a semiconductor inspecting device and inspecting method mainly used in a manufacturing step of a semiconductor.

(2) Description of Related Art

In the semiconductor manufacturing step, if a foreign material or a pattern defect exists on a semiconductor substrate (a wafer), a defect such as an insulation failure, a short circuit or the like is caused.

Further, if a small foreign material exists in accordance with a refining of a semiconductor device, a smaller foreign material causes an insulation failure of a capacitor and a breakage of a gate oxide film and the like.

These foreign materials are mixed in various states such as being generated from a movable portion of a feeding device, being generated from a human body, being generated on the basis of a reaction within a processing device by a process gas, being mixed with a chemical or a material, and the like.

In the same manner, in a manufacturing step of a liquid crystal display device, if a foreign material is attached onto a pattern or a defect is generated due to some reason, the display device can not be used. In a manufacturing step of a printed circuit board, the same condition is applied, and an attachment of the foreign material causes a short circuit of a pattern and a defect connection.

Conventionally, as one of techniques for detecting the small foreign material and the defect on this kind of semiconductor substrate at a high speed and a high sensitivity, there is disclosed a technique of doing away with a misreport caused by a pattern and being capable of inspecting a foreign material and a defect at a high sensitivity and a high reliability, by detecting a scattered light from the foreign material generated in the case that the foreign material is attached onto the semiconductor substrate by irradiating a laser beam onto the semiconductor substrate, and comparing with a result of inspection of the same kind of semiconductor substrate which is inspected just before, as described in patent document 1 (JP-A-62-89336).

In order to carry out a comparative inspection of an inspected substrate at a high speed and a high sensitivity, such as the patent document 1 (JP-A-62-89336), an accurate inspecting stage and position correcting control technique are necessary.

As an example of the stage and position correcting technique as mentioned above, there is an example of a position correcting control method of an XY stage using a reference mask, which is described as an example of a semiconductor manufacturing device in patent document 2 (JP-A-7-325623).

In the prior art, in order to detect the foreign material and the pattern defect on the refined semiconductor substrate at a high speed, it is necessary to make a positional displacement amount of the inspecting stage projected on an inspected image as small as possible, and an inspecting stage having a higher speed and a higher precision is necessary.

Further, it is necessary to suppress a cost increase caused by an improvement of the precision of the inspecting stage.

### BRIEF SUMMARY OF THE INVENTION

The present invention is made by taking the problem mentioned above into consideration, and an object of the present invention is to provide an inspecting method and an inspecting device which can detect a foreign material and a pattern defect at a high speed and a high precision, and can suppress a cost increase, by correcting a photographed image of an inspected subject and regulating a direction of an image sensor photographing the inspected subject without depending only upon a positional displacement correcting control of a stage.

In accordance with the present invention, there is provided an inspecting method of inspecting an inspected subject mounted on a moving stage by photographing by an image sensor, comprising the steps of:

determining a positional displacement amount between a target position and an actual position of the stage moving for photographing; and

regulating and correcting a direction of the image sensor with respect to the inspected subject in correspondence to the positional displacement amount, in the photographing at the target position.

Further, in accordance with the present invention, there is provided an inspecting method of inspecting an inspected subject mounted on a moving stage by photographing by an image sensor, comprising the steps of:

determining a positional displacement amount between a target position and an actual position of the stage moving for photographing; and

carrying out a sampling position correction in correspondence to the positional displacement amount, on the basis of a photographed image sampling from a photographed range of the target position which is photographed.

Further, in accordance with the present invention, there is provided an inspecting device comprising:

a stage moving while mounting an inspected subject thereon; and

an image sensor photographing the inspected subject,

wherein the inspecting device comprises:

a memory portion storing an information indicating a positional displacement amount between a target position and an actual position of the stage which moves; and

a control portion regulating and correcting a direction of the image sensor with respect to the inspected subject on the basis of the information.

Further, in accordance with the present invention, there is provided an inspecting device comprising:

a stage moving while mounting an inspected subject thereon; and

an image sensor photographing the inspected subject,

wherein the inspecting device comprises:

a memory portion storing an information indicating a positional displacement amount between a target position and an actual position of the stage which moves; and

a processing portion sampling a photographed image by carrying out a sampling position correction in correspondence to the information, on the basis of a photographed image sampling from a photographed range of the photographed target position.

In the inspecting method in accordance with the present invention, it is preferable that the photographed range of the target position is larger than the sampled photographed image.

Further, in accordance with the present invention, there is provided an inspecting method of photographing an inspected subject mounted on a stage moving vertically and horizontally in a coordinate of X-axis and Y-axis by an image sensor, comprising the steps of:

determining a positional displacement amount between a target position and an actual position of the stage which moves, on the coordinate;

regulating and correcting a direction of the image sensor with respect to the inspected subject in correspondence to the positional displacement amount corresponding one axis side on the coordinate; and

carrying out a sampling position correction in correspondence to the positional displacement amount corresponding to the other side axis on the coordinate, in an image sampling from a photographed range of the photographed target position.

Further, in accordance with the present invention, there is provided an inspecting method of photographing an inspected subject mounted on a moving stage, and comparing and collating a photographed image, comprising the steps of:

individually determining a positional displacement amount between a target position and an actual position of the stage moving toward an individual image photographing; and

regulating and correcting a direction of the image sensor with respect to the inspected subject in correspondence to the positional displacement amount, in an image photographing at the individual target position.

Further, in accordance with the present invention, there is provided an inspecting method of photographing an inspected subject mounted on a moving stage, and comparing and collating a photographed image, comprising the steps of:

individually determining a positional displacement amount between a target position and an actual position of the stage moving toward an individual image photographing; and

carrying out a sampling position correction in correspondence to each of the positional displacement amounts, in a photographed image sampling from a photographed range of each of the target positions.

Further, in accordance with the present invention, there is provided an inspecting method of photographing an inspected subject mounted on a stage moving vertically and horizontally in a coordinate of X-axis and Y-axis by an image sensor, comprising the steps of:

determining a positional displacement amount between a target position and an actual position of the stage which moves, on the coordinate;

regulating and correcting a direction of the image sensor with respect to the inspected subject in correspondence to the positional displacement amount corresponding one axis side on the coordinate; and

regulating and correcting in correspondence to the positional displacement amount corresponding to the other side axis on the coordinate by the stage.

Further, in accordance with the present invention, there is provided an inspecting method of photographing an inspected subject mounted on a stage moving vertically and horizontally in a coordinate of X-axis and Y-axis by an image sensor, comprising the steps of:

determining a positional displacement amount between a target position and an actual position of the stage which moves, on the coordinate;

regulating and correcting in correspondence to the positional displacement amount corresponding to one side axis on the coordinate, in a photographed image sampling from a photographed range of the photographed target position; and

regulating and correcting in correspondence to the positional displacement amount corresponding to the other side axis on the coordinate by the stage.

Further, in accordance with the present invention, there is provided an inspecting method of photographing and inspecting an inspected subject mounted on a moving stage by an image sensor, comprising the steps of:

calculating a positional displacement amount between a target position and an actual position of the stage, on the basis of an image positional displacement amount between a reference image (801) and a comparative image (802) photographed by the image sensor.

In the inspecting method in accordance with the present invention, it is preferable to regulate and correct in correspondence to the positional displacement amount in the movement of the stage.

In the inspecting method in accordance with the present invention, it is preferable to carry out a sampling position correction in correspondence to the positional displacement amount, in the photographed image sampling from the photographed range.

In the inspecting method in accordance with the present invention, it is preferable to correct a position of the image sensor in correspondence to the positional displacement amount, in the photographing to be inspected.

In accordance with the present invention, it is possible to detect a foreign material and a pattern defect at a high speed and a high precision, and it is possible to suppress a cost increase.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWINGS

FIG. 1 is a view showing an example of a structure of a defect inspecting device in accordance with an embodiment 1 of the present invention;

FIGS. 2A and 2B are views showing an inspected substrate in which LSIs corresponding to a sample of an inspected subject are arranged, in accordance with the embodiment 1 of the present invention;

FIG. 3 is a view for explaining three inspecting illumination lights relating to an illumination optical system of the defect inspecting device in accordance with the embodiment 1 of the present invention;

FIGS. 4A and 4B are views showing an optical system including an illumination lens of the illumination optical system of the defect inspecting device in accordance with the embodiment 1 of the present invention;

FIG. 5 is a view showing a function of the illumination lens of the illumination optical system of the defect inspecting device in accordance with the embodiment 1 of the present invention;

FIG. 6 is a view showing a stage relevance in accordance with the embodiment 1 and an embodiment 2 of the present invention;

FIG. 7 is a view showing a moving distance setting map in accordance with the embodiment 1 and the embodiment 2 of the present invention;

FIG. 8 is a moving distance map drawing in accordance with the embodiment 1 and the embodiment 2 of the present invention;

FIG. 9 is a view showing the other example of the structure of the defect inspecting device in accordance with the embodiment 1 of the present invention;

FIG. 10 is a view showing a photographed range at a time of inspecting, a comparative inspected image after a positional correction, and a result of an image comparative inspection, in accordance with the embodiment 1 of the present invention;

FIG. 11 is a view showing further the other example of the structure of the defect inspecting device in accordance with the embodiment 1 of the present invention;

FIG. 12 is a detailed view of an image sensor positional correction portion in accordance with the embodiment 2 of the present invention;

FIG. 13 is a view showing a photographed range at a time of inspecting, a comparative inspected image after a positional correction, and a result of an image comparative inspection, in accordance with the embodiment 2 of the present invention;

FIG. 14 is a flow chart in accordance with the embodiment 1 of the present invention;

FIG. 15 is a flow chart in accordance with the embodiment 2 of the present invention;

FIG. 16 is a flow chart in accordance with an embodiment 3 of the present invention;

FIG. 17 is a flow chart in accordance with the embodiment 3 of the present invention;

FIG. 18 is a flow chart in accordance with the embodiment 3 of the present invention; and

FIG. 19 is a view showing a positional displacement amount of each of images within a photographed range at a time of an inspecting motion, in accordance with the embodiment 3 of the present invention.

### DETAILED DESCRIPTION OF THE INVENTION

A description will be given below of embodiments in accordance with the present invention with reference to the accompanying drawings.

In the following drawings, a description will be given by attaching the same reference numerals to the same functional portions.

### Embodiment 1

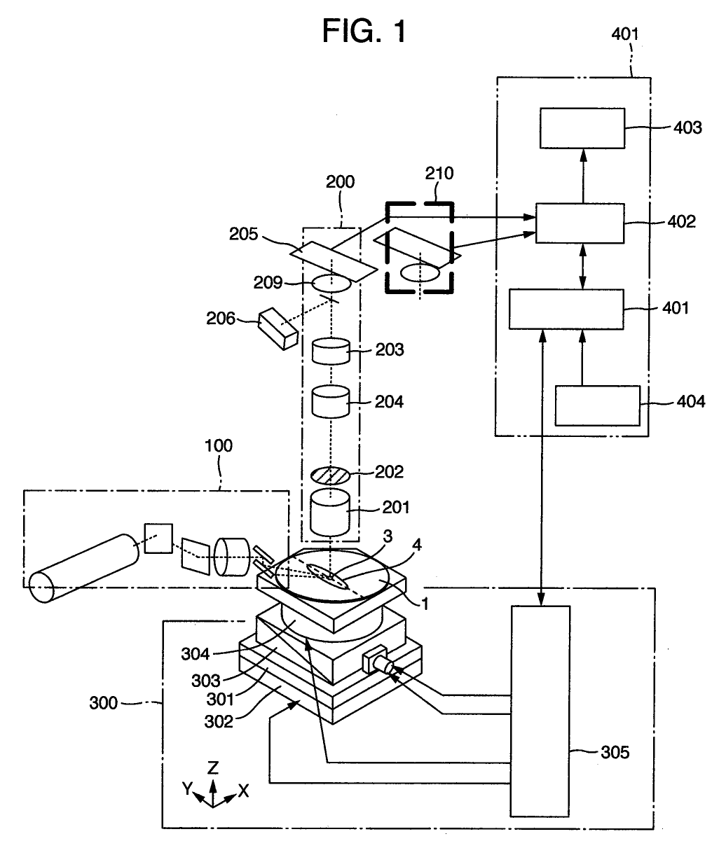

Next, a description will be given of a device structure of an inspecting device in accordance with an embodiment 1 of the present invention with reference to FIGS. 1 to 5.

A description will be given of an embodiment of a defect inspecting device.

The defect inspecting device mounts an inspected substrate 1 thereon, and has a beam spot 3 corresponding to a slit-like illumination region irradiated as a slit shape on the inspected substrate, a detected region 4 of an image sensor, and a stage portion 300 constituted by an X stage 301 and a Y stage 302 which can scan an inspected region within the inspected substrate in an XY direction and can relatively move with respect to an optical system, a Z stage 303 which can focus on a surface of the inspected substrate, a θ stage 304 and a stage controller 305.

Further, the defect inspecting device has an illumination optical system 100 constituted by a laser light source, a beam expander, an optical filter group, a mirror, an optical branch element (or a mirror) capable of switching to a glass plate, and a beam spot image forming portion.

Further, the defect inspecting device has a detection optical system 200 constituted by a detection lens 201, a spatial filter 202, an image forming lens 203, a zoom lens group 204, a linear image sensor (an image sensor) 205, an upward observation system 206 capable of observing a detection region of the image sensor, a polarizing beam splitter 209, and a branch detection optical system 210 for simultaneously inspecting two sensors.

Further, the defect inspecting device has a control system 400 constituted by a signal processing portion 402 constructed by an A/D converting portion, a data memory capable of delaying, a difference processing circuit taking a difference of signal between chips, a memory temporarily storing a difference signal between the chips, a threshold value calculating process portion setting a pattern threshold value, and a comparator circuit, an output means storing a defect detection result of a foreign material or the like and outputting a defect detection result, a control CPU portion 401 controlling a drive of a motor or the like, a coordinate and a sensor, a display portion 403 and an input portion 404.

It is preferable to employ a third higher harmonic wave THG of a YAG laser having a high output and a wave length 355 nm as a laser light source of the illumination optical system 100, however, it is not necessary to be 355 nm. In other words, it is possible to employ the other light sources such as a laser light source Ar laser, a nitrogen laser, an He—Cd laser, an excimer laser and the like.

The linear image sensor 205 may be constituted by a CCD or TDI (time delay integration) sensor. In the case of the CCD, since a pixel size is about 10 μm, it is possible to consider as a linear detection, and a sensitivity reduction is not generated by incorporating an image which is not focused in a scanning direction.

On the other hand, since an integral of an image at a fixed pixel exists in the scanning direction, it is desirable to reduce an amount incorporating the image which is not focused, on the basis of a countermeasure making an illumination width small, tilting the TDI sensor or the like.

A coordinate system is shown in a left lower side of FIG. 1. An XY axes are set on a plane, and a Z axis is set to a vertically upward side. An optical axis of the detection optical system 200 is arranged along the Z axis.

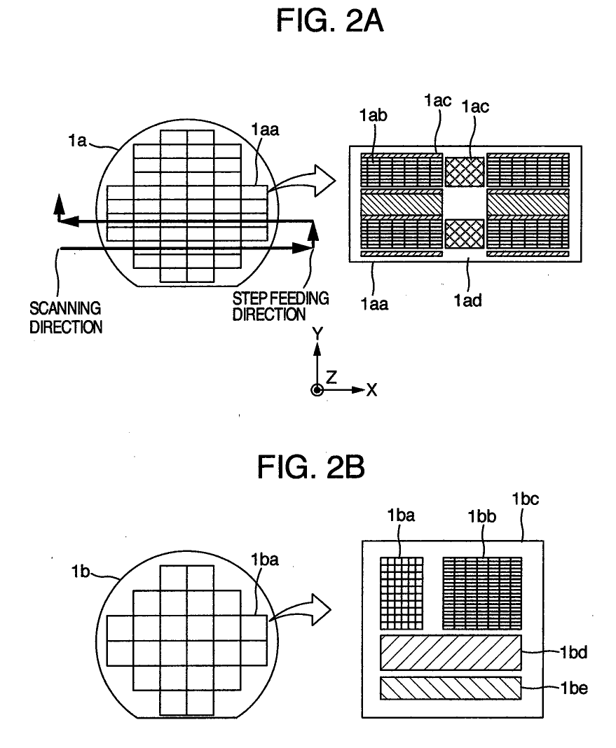

First, a description will be given of a sample corresponding to a subject of an inspection of the defect inspecting device in accordance with the embodiment of the present invention with reference to FIGS. 2A and 2B.

An inspected substrate 1a shown in FIG. 2A has a memory LSI chip 1aa arranged in two dimension at a predetermined interval. The memory LSI chip 1aa mainly has a memory cell region 1ab, a peripheral circuit region 1ac constituted by a decoder, a control circuit and the like, and the other region 1ad.

The memory cell region 1ab has a memory cell pattern which is regularly arranged in two dimension, that is, a repeated memory cell pattern. The peripheral circuit region 1ac has a non-repeated pattern which is not regularly arranged in two dimension.

The inspected substrate 1b shown in FIG. 2B has an LSI chip 1ba such as a microcomputer or the like arranged in two dimension at a predetermined interval.

The LSI chip 1ba such as the microcomputer or the like mainly has a register group region 1bb, a memory portion region 1bc, a CPU core portion region 1bd, and an input and output portion region 1be. In this case, FIG. 2B conceptually shows a layout of the memory portion region 1bc, the CPU core portion region 1bd and the input and output portion region 1be.

The register group region 1bb and the memory portion region 1bc have a pattern which is regularly arranged in two dimension, that is, a repeated pattern. The CPU core portion region 1bd and the input and output portion region 1be have a non-repeated pattern.

As mentioned above, the inspected subject of the defect inspecting device in accordance with the embodiment of the present invention has the regularly arranged chip such as the inspected substrate (wafer) 1 shown in FIG. 2, however, a minimum line width is different per region within the chip, and the repeated pattern and the non-repeated pattern are included. Therefore, various aspects can be considered.

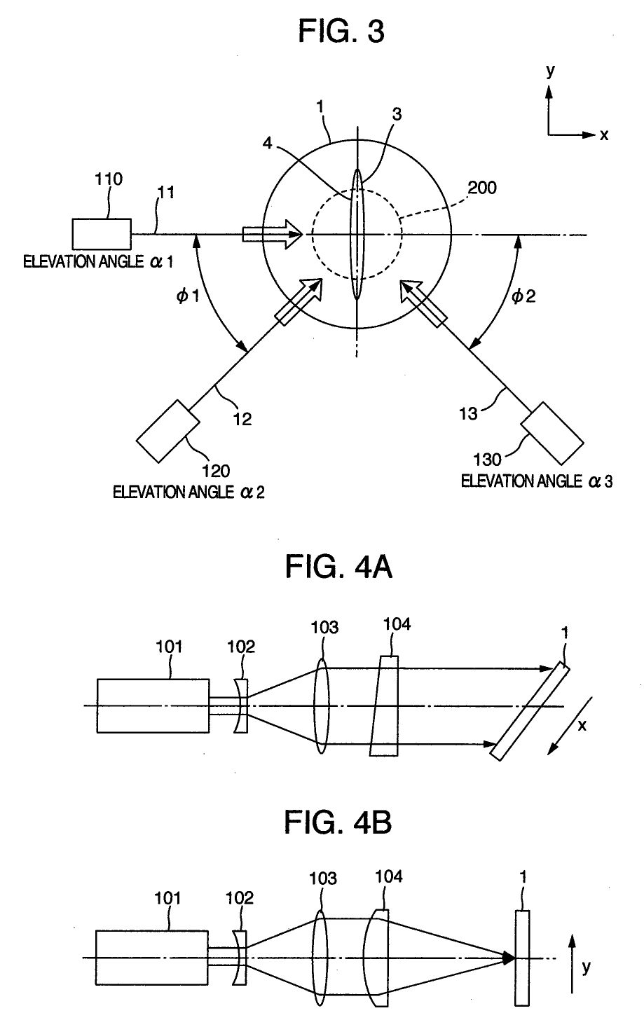

A description will be given of first to third three beam spot image forming portions 110 120 and 130 of the illumination optical system 100 with reference to FIG. 3.

FIG. 3 is a view obtained by seeing the inspected substrate from the above.

An inspecting illumination light 11 in the X-axis direction is irradiated via the first beam spot image forming portion 110, an inspecting illumination light 12 in a direction which is inclined at −45 degree with respect to the Y axis is irradiated via the second beam spot image forming portion 120, and an inspecting illumination light 13 in a direction which is inclined at 45 degree with respect to the Y axis is irradiated via the third beam spot image forming portion 130.

The non-repeated pattern on the inspected substrate is mainly constituted by linear patterns which are formed in parallel or at right angles. The linear patterns extend in the direction of X axis or Y axis. Since the patterns on the inspected substrate 1 are formed in a protruding manner, a concave portion is formed between the adjacent linear patterns.

Accordingly, the inspecting illumination lights 12 and 13 irradiated from the direction which is inclined at 45 degree with respect to the X axis and the Y axis are shielded by the protruding circuit patterns, and can not irradiate the concave portion between the linear patterns.

The inspecting illumination lights 11, 12 and 13 are irradiated so as to be inclined at a predetermined elevation angle α with respect to the surface on the inspected substrate. Particularly, it is possible to reduce an amount of detection of scattered light from a lower surface of a transparent thin film by making the elevation angle α of the inspecting illumination lights 12 and 13 small.

The elongated beam spot 3 is formed on the inspected substrate by these inspecting illumination lights 11, 12 and 13. The beam spot 3 extends along the Y-axis direction. A length in the Y-axis direction of the beam spot 3 is larger than the detection region 4 for the image sensor of the linear image sensor 205 of the detection optical system 200.

A description will be given of a reason for setting three beam spot image forming portions 110, 120 and 130 in the illumination optical system 100. On the assumption that angles which images obtained by projecting the inspecting illumination lights 12 and 13 on the XY plane form with respect to the X axis are set to respectively φ1 and φ2, the relation φ1=φ2=45 degree is established in the present embodiment.

Since the main direction of the non-repeated pattern on the inspected substrate is constituted by the X-axis or Y-axis linear pattern, the light is input to the pattern from a direction of 45 degree.

Accordingly, a 0-stage diffracted light enters as a component in the direction of X axis or Y axis into an entrance pupil of the detection lens 201, however, since a regular reflection light has a low angle α in the case that the illumination elevation angle α is a low angle, the diffracted light in the X-axis or Y-axis component also comes away from a region of the entrance pupil of the detection lens 201 in the same manner, and can avoid from entering into the detection optical system 200. This is described in detail, for example, JP-B2-3566589 (refer particularly to paragraphs 0033 to 0036), and a description thereof will be omitted here.

The non-repeated pattern on the inspected substrate is mainly constituted by the linear patterns which are formed in parallel and at right angles. These linear patterns extend in the direction of X axis or Y axis. Since the patterns on the inspected substrate are formed in a protruding manner, a concave portion is formed between the adjacent linear patterns.

Accordingly, the inspecting illumination lights 12 and 13 irradiated from the direction which is inclined at 45 degree with respect to the X axis and the Y axis are shielded by the protruding circuit pattern, and can not irradiate the concave portion between the linear patterns.

Then, there is provided the first beam spot image forming portion 110 generating the inspecting illumination light 11 along the X-axis direction. Since it is possible to irradiate the concave portion between the liner patterns by the inspecting illumination light 11 as mentioned above, it is possible to detect the defect such as the foreign material or the like existing there.

On the basis of the direction of the linear pattern, the sample may be inspected by being rotated at 90 degree, and the inspecting illumination light 11 may be irradiated along the Y-axis direction.

In the case of irradiating along the X-axis direction and irradiating the concave portion between the linear patterns such as the inspecting illumination light 11, it is necessary to shield the 0-stage diffracted light in such a manner as to prevent the image sensor from detecting the 0-stage diffracted light. Accordingly, the spatial filter 202 is provided.

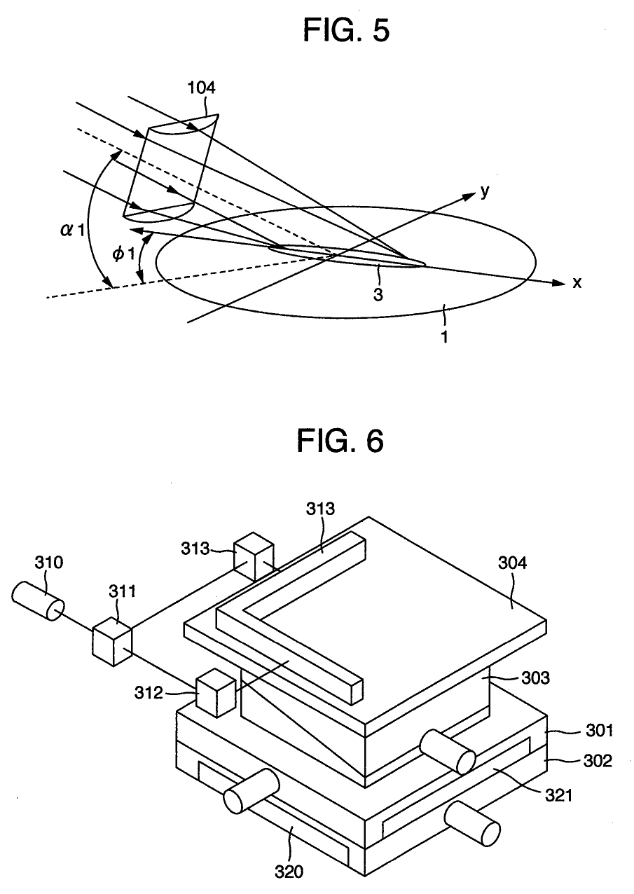

A description will be given of a method of forming the elongated beam spot 3 with reference to FIGS. 4 and 5.

FIGS. 4 and 5 show only the laser light source 101, the concave lens 102, the convex lens 103 and the illumination lens 104 in the illumination optical system 100, and the other constituting elements are omitted.

The illumination lens 104 is constituted by a cylindrical lens having a conical curved surface, has a linearly changing focal distance along a longitudinal direction as shown in FIG. 4A, and has a cross section of the flat convex lens as shown in FIG. 4B.

As shown in FIG. 5, it is possible to generate the slit-shaped beam spot 3 which is narrowed down in the Y direction and collimated in the X direction with respect to the illumination light input while being inclined with respect to the inspected substrate. The angle of the illumination light with respect to the surface of the inspected substrate is set to α1, and the angle which the image of the inspecting illumination light 11 projected on the inspected substrate forms the X axis is set to 1.

It is possible to achieve the illumination having the parallel light in the X direction and having the relation φ1=near 45 degree, by using the illumination lens 104 as mentioned above. A manufacturing method of the illumination lens 104 having the conical curved surface is described in detail, for example, in JP-B2-3566589 (refer particularly to paragraphs 0027 to 0028), and the illumination lens 104 having the conical curved surface can be manufactured in accordance with a known method.

Further, the embodiment 1 will be described in detail by using FIGS. 6 to 10 and 14. This embodiment relates to an image processing in accordance with the present invention.

An object of the present embodiment is to obtain an effect which is equal to or more than the case that a positional displacement amount with respect to a target position of the stage is inspected by a high-precision stage while positioning a photographed range in accordance with the image processing.

FIG. 6 is a partly detailed view of the stage portion 300 in FIG. 1.

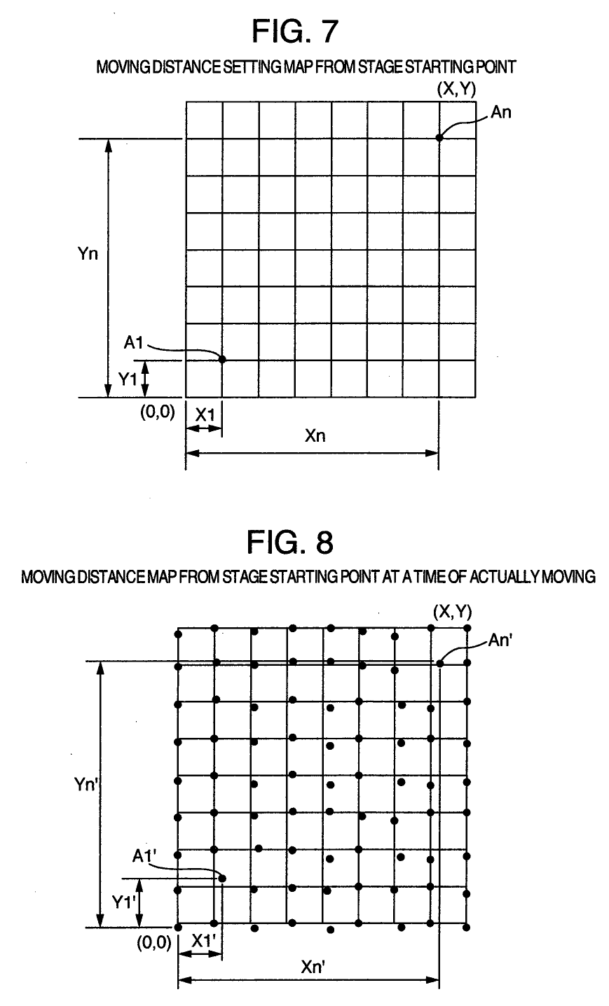

FIG. 7 is a stage starting point moving distance setting map for moving the X stage 302 and the Y stage 301 to the target coordinate.

FIG. 8 is a map obtained by measuring an actual moving distance from the stage starting point at a time of moving the X stage 302 and the Y stage 301 along the moving distance setting map in FIG. 7.

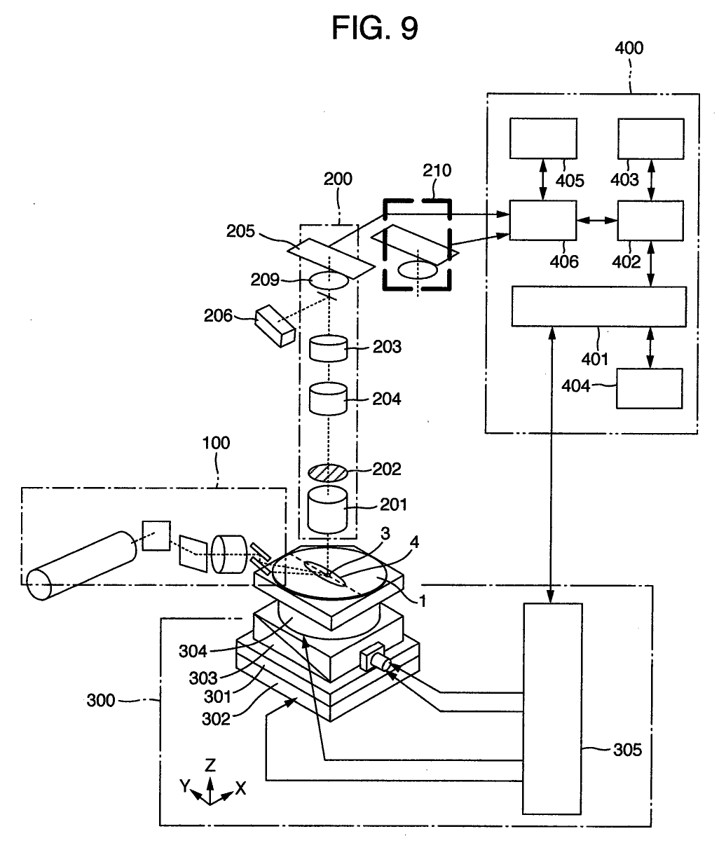

FIG. 9 is a view showing a device structure in accordance with the present embodiment, and is a structure view obtained by adding a memory portion 405 and an image processing portion 406 to the device structure in FIG. 1.

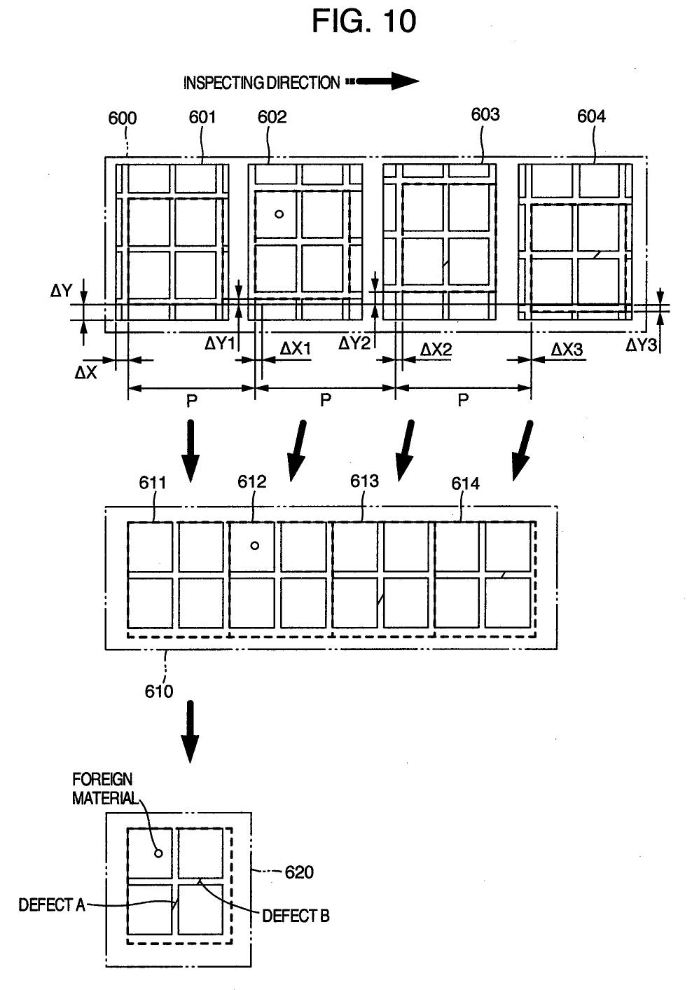

FIG. 10 is a view showing a photographed range 600 at a time of inspecting, and a comparative inspection image 610 and an image comparing inspection result 620 after correcting the position.

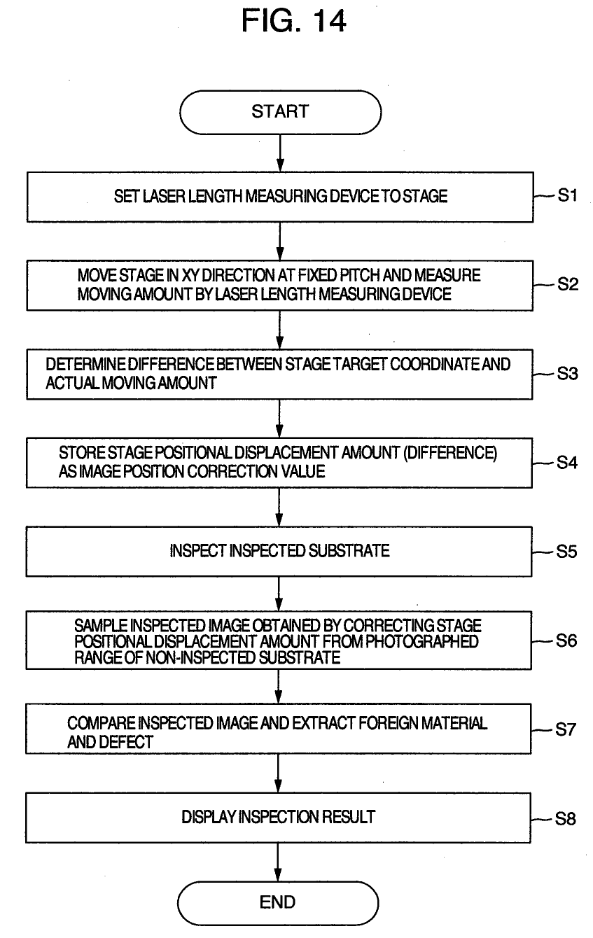

FIG. 14 is a view showing a flow chart of the present embodiment.

A description will be given in detail of the present embodiment along the flow chart in FIG. 14.

As a step S1, laser length measuring devices 310 to 314 are set to the stage portion 300 shown in FIG. 6. The laser length measuring devices 310 to 314 may be detached after measuring the stage positional distance amount, however, may be mounted to the stage portion 300.

Further, although a precision drops in some degree, linear scales 320 and 321 may be arranged respectively in the X stage 302 and the Y stage 301.

As a step S2, the X stage 302 and the Y stage 301 of the stage portion 300 shown in FIG. 6 are moved at fixed pitches (X1 and Y1) with respect to a moving target position A1 along the moving distance setting map in FIG. 7.

The moving amount along the moving distance setting map may an encoder of the X stage 302 and the Y stage 301 or a coordinate of the linear scales 320 and 321 for stage. At this time, a moving position (X1′, Y1′) of an actually moving position A11 shown in FIG. 8 is measured.

In the same manner, a moving distance map from a stage starting point in FIG. 8 is finished by moving at a fixed pitch (Xn, Yn) with respect to a moving target position An, and measuring a moving position (Xn′, Yn′) of an actually moving position An′.

As a step S3, differences ΔX and ΔY of the actual moving amount with respect to the moving target position are determined from data picked up in the step S2. An example of a calculation expression will be shown below.

(Example)

Difference ΔX of X stage 302=(X1)−(X1′) (numerical expression 1)

Difference ΔY of Y stage 301=(Y1)−(Y1′) (numerical expression 2)

It is possible to restrict the positional displacement amount on the basis of a pitch displacement from the repeated pattern of the inspected substrate 1 as small as possible by making a measuring pitch of the moving distance measuring map from the stage starting point small.

As a step S4, the differences ΔX and ΔY of the stage positional displacement amount are stored as position correction values ΔX′ and ΔY′ of the inspected image in the memory portion 405 shown in FIG. 9. As a step S5, the inspected substrate 1 shown in FIG. 9 is inspected, and inspected images 601 to 604 within the photographed range 600 shown in FIG. 10 are incorporated.

As a step S6, sampling inspected images 611 to 614 are sampled from the photographed range 600, and a comparative inspection image 610 is formed, in the image processing portion 406 shown in FIG. 9. In this sampling, since the correction is carried out on the basis of the position correction values ΔX′ and ΔY′ of the inspected image which is previously stored in the memory portion 405, the comparative inspection image 610 in which the positional displacement amount is corrected is obtained.

Since the photographed range 600 of the target position is set larger than a photographed image (a sampling inspected image) sampled in expectation of the stage positional displacement amount (the positional displacement amount), it is possible to sample an inspected image which covers a whole of the inspection range.

As a step S7, the comparative inspection image 610 is comparatively processed by the signal processing portion 402 shown in FIG. 9, and a foreign material, a defect A and a defect B are detected on the basis of the image comparative inspection result 620 shown in FIG. 10. As a step S8, the result of detection in the step S7 is displayed on the display portion 403.

The present method can enlarge the small positional displacement amount of the stage so as to recognize, by enlarging and inspecting the inspected substrate 1 by the zoom lens group 204 shown in FIG. 9.

For example, on the assumption that the stage positional displacement amount is 5 μm and a magnification of the zoom lens is between quintuple and twentyfold, the positional displacement amount of the stage can be enlarged to 25 μm to 100 μm so as to be recognized. On the contrary, the lower magnification of the zoom lens magnification causes a smaller moving amount and is easily controlled.

Accordingly, it is possible to relax a request precision of the positional correction with respect to the stage positional displacement amount, and it is possible to easily correct the position on the basis of the inspected image. Further, since it is possible to easily positional correct the stage positional displacement amount on the basis of the inspected image, it is possible to relax the stage request precision.

Further, since the θ stage 304 which is away from the X stage 302 and the Y stage 301 or the portion near the θ stage 304 is measured directly by the laser length measuring device, it is possible to improve a correcting precision of the positional displacement amount caused by a yawing, a pitching and a rolling of the stage.

Further, in the comparative inspection which does not employ the positional correction on the basis of the inspected image using the conventional accurate stage, it is necessary to employ the comparing process which takes into the positional displacement amount of the stage for the comparative pixel number of the image sensor, for example, the comparing process including the positional displacement amount for three pixels, however, since the present method can comparatively process the comparative pixel number of the image sensor by one pixel, an image comparing precision is improved, and it is possible to detect the foreign material and the defect which have been conventionally missed out in the comparing process.

Further, it is possible to carry out the comparing process within one pixel by carrying out a sub pixel alignment at a time of an under sampling.

Further, in the conventional method, it is necessary to set the non-inspection region or inspect at the low sensitivity for detecting the portion near the dark pattern or the saturated portion, due to the positional displacement of the inspected image of the portion having the dark pattern or the saturated portion, as the problem of the dark field (DF) inspecting device, however, the present method has an effect that it is possible to make the non-inspection region and the low sensitivity region small.

The present method is a method which is preferable for the device for comparatively inspecting while having the repeated pattern, as far as the device provided with the XY stage and the image sensor.

### Embodiment 2

A description will be given of an embodiment relating to a control of the photographed range in accordance with the present invention with reference to FIGS. 6 to 9, 11 to 13 and 15.

An object of the present embodiment is to carry out a positioning of an inspected image by positional correcting and controlling a positional displacement amount with respect to a target position of the stage by an image sensor, and obtain an effect which is equal to or more than the case of inspecting by the high-precision stage.

Since FIGS. 6 to 9 are described in the embodiment 1, the description will be omitted.

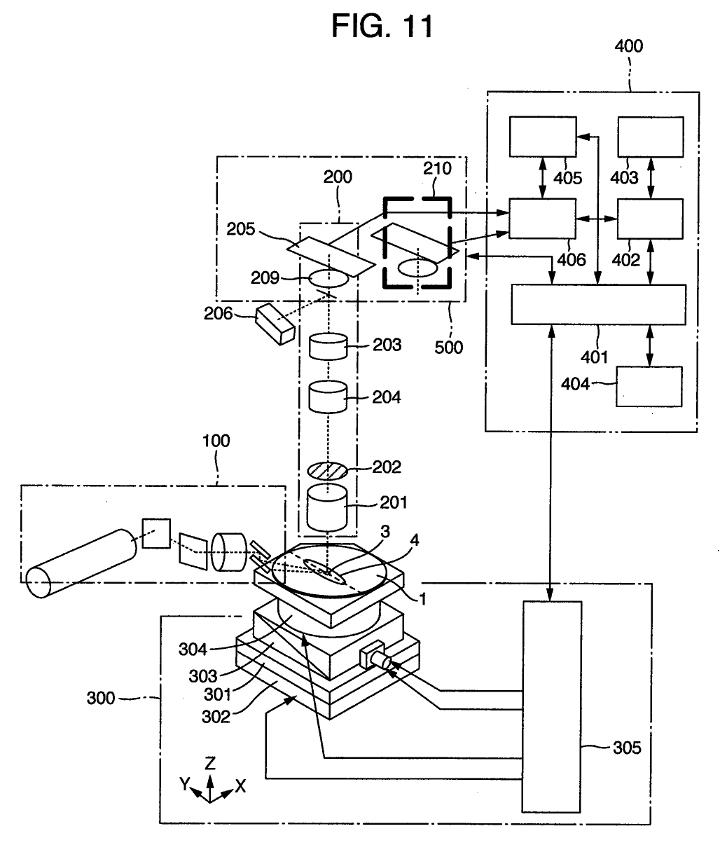

FIG. 11 is a view showing a device structure of the present embodiment 2.

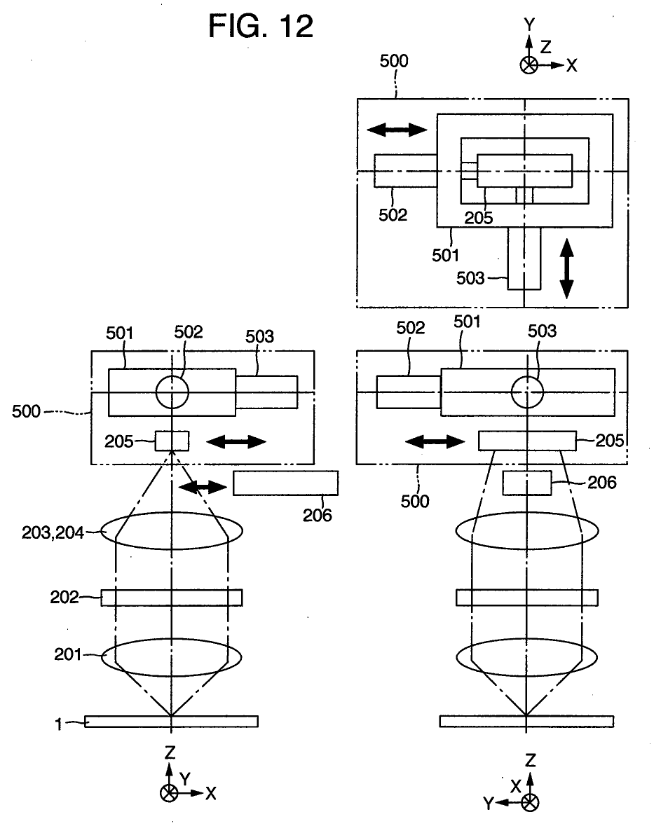

FIG. 12 is a detailed view of an image sensor positional correction portion of the present embodiment.

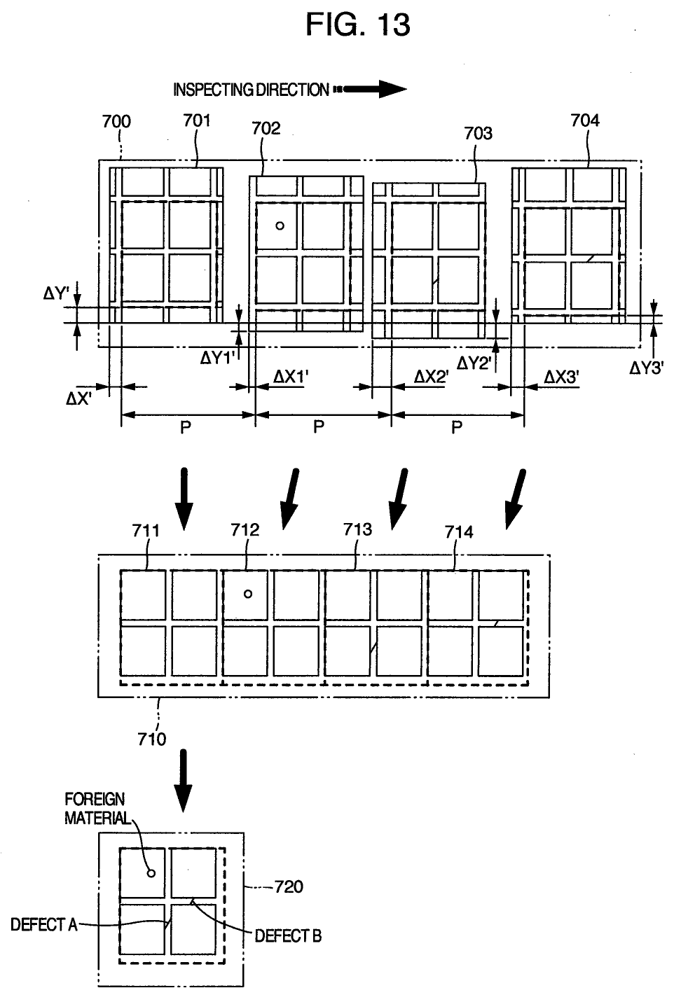

FIG. 13 is a view showing a photographed range 700 at a time of inspecting, a positional inspection image 710 after the positional correction and an image comparative inspection result 720.

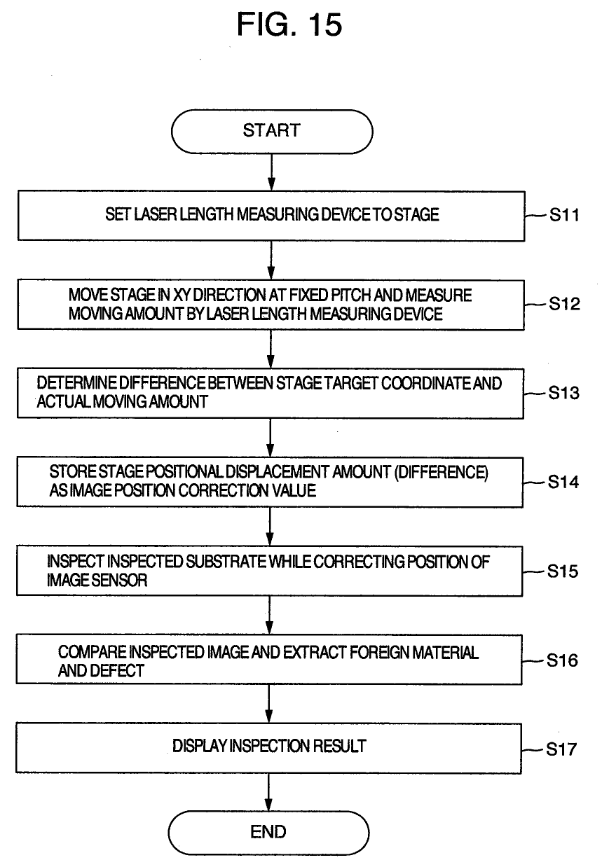

FIG. 15 is a view showing a flow chart of the present embodiment.

A description will be in detail given below of the present embodiment along the flow chart in FIG. 15.

As a step S11, the laser length measuring devices 310 to 314 are set to the stage portion 300 shown in FIG. 6.

The laser length measuring devices 310 to 314 may be detached after measuring the stage positional distance amount, however, may be mounted to the stage portion 300.

As a step S12, the X stage 302 and the Y stage 301 of the stage portion 300 shown in FIG. 6 are moved at fixed pitches (X1 and Y1) with respect to the moving target position A1 along the moving distance setting map in FIG. 7.

At this time, the moving position (X1′, Y1′) of the actually moving position A11 shown in FIG. 8 is measured.

In the same manner, the moving distance map from the stage starting point in FIG. 8 is finished by moving at the fixed pitch (Xn, Yn) with respect to the moving target position An, and measuring the moving position (Xn′, Yn′) of the actually moving position An′.

As a step S13, the differences ΔX and ΔY of the actual moving amount with respect to the moving target position are determined from the data picked up in the step S12. A calculation expression employs the (numerical expression 1) and (numerical expression 2) described in the embodiment 1 mentioned above.

As a step S14, the differences ΔX and ΔY of the stage positional displacement amount are stored as the position correction values ΔX′ and ΔY′ of the image sensor 205 in the memory portion 405 shown in FIG. 11.

As a step S15, an inspecting motion of the inspected substrate 1 is carried out while carrying out the positional correction control by an image sensor positional correction portion 500 shown in FIG. 12, such as inspected images 701 to 704 within a photographed range 700 shown in FIG. 13 by the control CPU portion 401, by referring to the positional correction values ΔX′, ΔY′, ΔX1′, ΔY1′, ΔX2′, ΔY2′, ΔX3′ and ΔY3′ of the image sensor 205 shown in FIG. 13 stored in the memory portion 405.

The image sensor positional correction portion 500 has an XY correcting mechanism 501, an X-axis motor 502, and a Y-axis motor 503.

The image sensor positional correction portion 500 regulates and corrects the positional displacement amount mentioned above (the difference amount between the target position and the actual position of the stage). The image sensor 205 moves in parallel to the stage in the direction of the X axis and the Y axis by the XY correcting mechanism 501 so as to regulate and correct the positional displacement amount.

In place of the method of the parallel movement, it is possible to regulate and correct the positional displacement amount on the basis of a regulation of a direction and an angle with respect to the stage.

In this case, the relation of ΔX′, ΔY′, ΔX1′, ΔY1′, ΔX2′, ΔY2′, ΔX3′ and ΔY3′ shows the positional correction amount of the adjacent images. As a step S16, a comparative inspection image 710 is formed from the image sensor inspected images 711 to 714 incorporated in the step S15 by the image processing portion 406.

The comparative inspection image 710 is comparatively processed by the signal processing portion 402 shown in FIG. 11, and the foreign material, the defect A and the defect B are detected from the image comparative inspection result 720 shown in FIG. 13. As a step S17, the detection result of the step S16 is displaced on the display portion 403. The present method can shorten the image processing time of the embodiment 1 and obtain an effect of reducing the executing step number.

As an application of the present invention, it is possible to employ a using method obtained by combining the embodiment 1 and the embodiment 2. For example, it is possible to employ a method of correcting the positional displacement amount of the X stage 302 in accordance with the image processing of the embodiment 1, and position correcting the positional displacement amount of the Y stage 301 within the image sensor photographed range of the embodiment 2.

Further, it is possible to employ a method of position correcting the positional displacement amount of the X stage 302 in the image sensor photographed range of the embodiment 2 and position correcting the positional displacement amount of the Y stage 301 in accordance with the image processing of the embodiment 1.

In other words, an application example obtained by combining the embodiment 1 and the embodiment 2 mentioned above is reworded by the inspecting method of photographing the inspected subject mounted on the stage moving vertically and horizontally in the coordinate of X-axis and Y-axis by an image sensor, including the steps of determining the positional displacement amount between the target position and the actual position of the stage which moves for photographing, on the coordinate, regulating and correcting the direction of the image sensor with respect to the inspected subject in correspondence to the positional displacement amount corresponding one axis side on the coordinate, and carrying out the sampling position correction in correspondence to the positional displacement amount corresponding to the other side axis on the coordinate, in the image sampling from the photographed range of the photographed target position.

In this application example, since the higher correcting precision can be expected in the image sampling positional correction than in the direction regulating correction of the image sensor, a selection in correspondence to a necessity should be carried out.

Further, as a further application example, the direction regulating correction of the image sensor and the image sampling positional correction are applied to the one axis side on the coordinate, and the correction in the other axis side is achieved by the positional correction control of the stage. For example, in the case that the moving operation frequency in the Y-axis direction is less, the high-precision positional correction control is used in the Y axis side.

### Embodiment 3

A description will be given of an embodiment relating to a control of the photographed range in accordance with the present invention and the positional control of the image sensor with reference to FIGS. 6 to 9, 11, 12 and 16 to 19.

An object of the present embodiment is to carry out an optimum positional correction control in correspondence to a stage performance by calculating the positional displacement amount (difference) with respect to the target position of the stage on the basis of each of the images photographed by the image sensor and obtained by the actual inspection motion, and selecting an optional threshold value setting and positional displacement correcting method with respect to the calculated stage positional displacement amount, thereby obtaining an effect which is equal to or more than the case of inspecting by the high-precision stage in spite of being inexpensive.

Since FIGS. 6 to 9 are described in the embodiment 1, the description will be omitted.

Since FIGS. 11 and 12 are described in the embodiment 2, the description will be omitted.

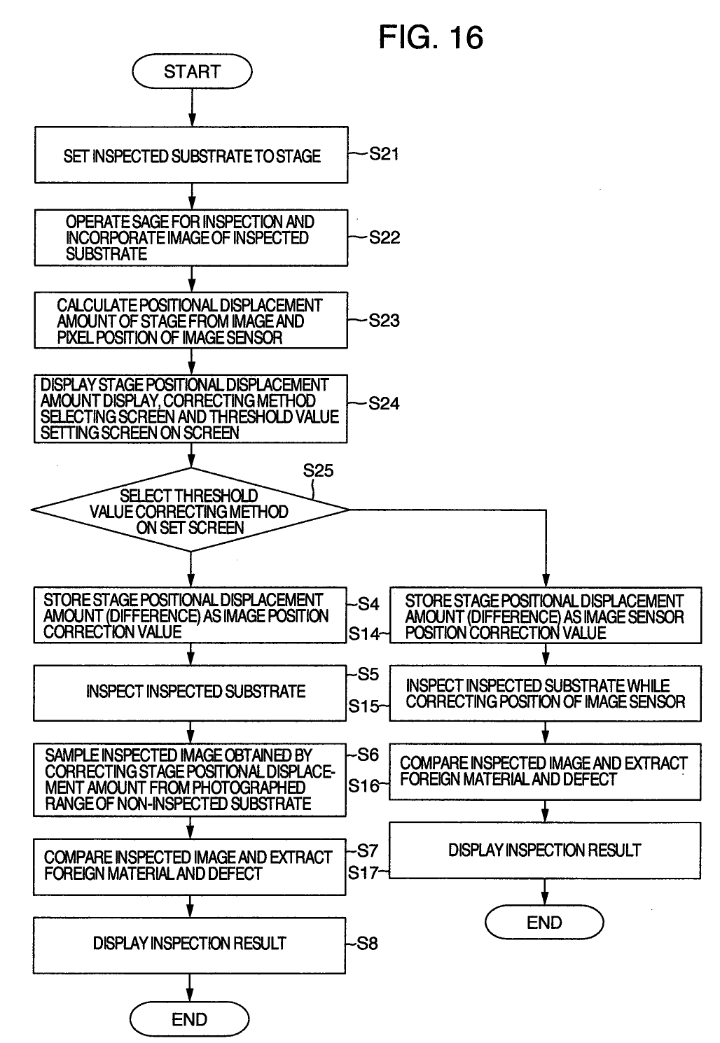

FIGS. 16 to 18 are views showing a flow chart of the present embodiment.

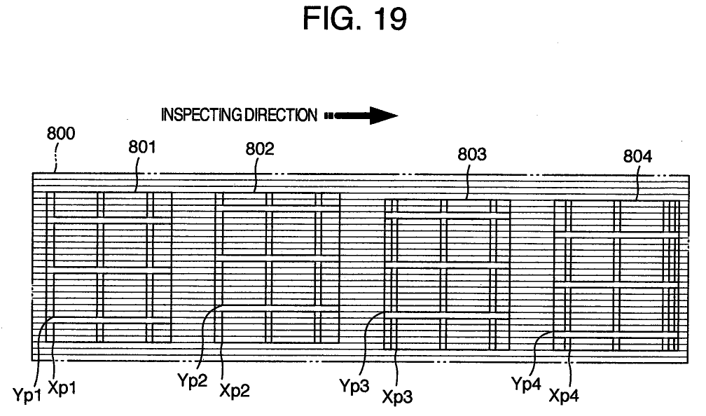

FIG. 19 is a view showing a positional displacement amount of each of images 801 to 804 within a photographed range 800 at a time of an inspecting motion.

A description will be in detail given below of the present embodiment along the flow chart in FIG. 16.

As a step S21, the inspected substrate 1 is set to the stage portion 300 shown in FIG. 11. As a step S22, the X stage 302 and the Y stage 301 shown in FIG. 11 are operated to be inspected, and the image 800 of the inspected substrate 1 shown in FIG. 19 is incorporated by the image sensor 205.

In this case, the image 801 is called as a reference image and the images 801 to 804 are called as a comparative image in the image 800.

As a step S23, a positional displacement amount (ΔXp, ΔYp) of the stage is calculated on the basis of the image positional displacement amount obtained by comparing a pixel No. (Xp1, Yp1) of an optional reference pattern projected onto the reference image 801 of the image 800 shown in FIG. 19, with each of pixel Nos. (Xp2, Yp2), (Xp3, Yp3) and (Xp4, Yp4) of the reference patterns projected onto the comparative images 802 to 804. An example of a calculation expression is shown as follows.

(Example)

Positional displacement amount (difference) of X stage 302: ΔXp

ΔXp=[(Xp1)−(Xp2)]×pixel size×magnification (numerical expression 1)

Positional displacement amount (difference) of Y stage 301: ΔYp

ΔYp=[(Yp1)−(Yp2)]×pixel size×magnification (numerical expression 2)

As a step S24, on the display portion 403, there are displayed the stage positional displacement amount calculated in the step S23, a correcting method selecting screen of the stage positional displacement amount and a threshold value setting screen.

As a step S25, the threshold value and the correcting method are selected. The threshold value can be optionally set in correspondence to the stage positional displacement amount.

Further, it is possible to optionally set the positional correcting method on the basis of the sampling range of the inspection image shown in Figs. S4 to S8 in FIGS. 10 and 14, and the positional correcting method on the basis of the image sensor shown in the steps S14 to S17 in FIGS. 13 and 15, in correspondence to the stage positional displacement amount and the motion frequency of the stage drive shaft, in accordance with the stage positional displacement amount.

For example, in the case of using the stage which has the small positional displacement amount and has the comparatively high precision, it is possible to delete the image sensor driving portion so as to make the image sensor driving portion inexpensive, by correcting the position within the image sampling range. Further, at a time of using the stage having the larger positional displacement amount, it is possible to correct the position to the range which can not be corrected in the image sampling range, by correcting the position by the image sensor.

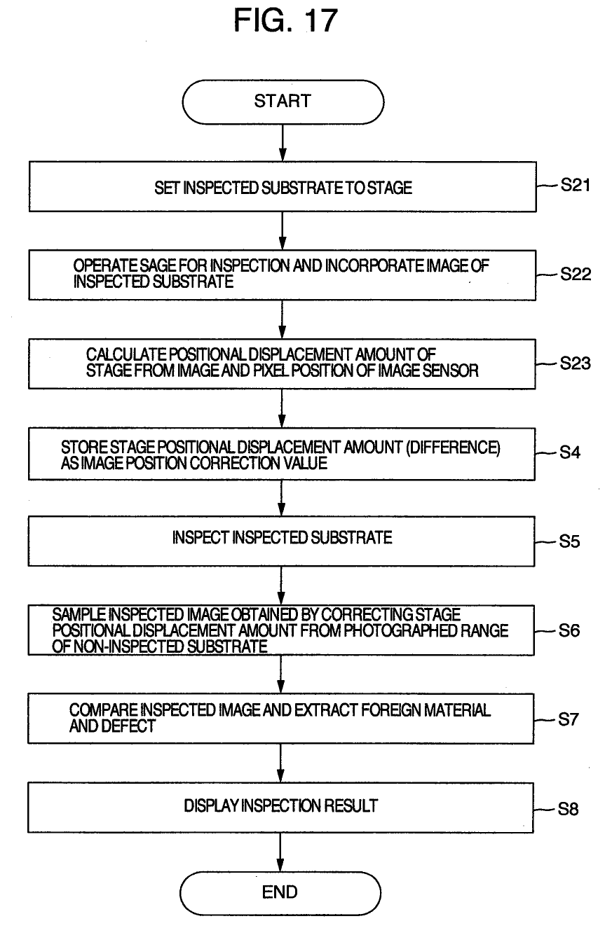

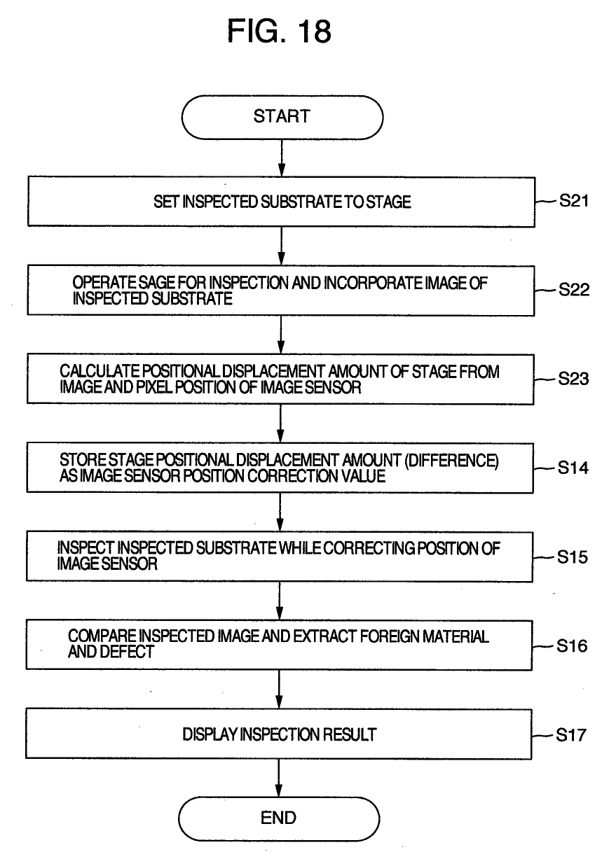

Further, the correcting method of the stage positional displacement amount may be decided without using the threshold value setting as shown in FIGS. 17 and 18.

Further, the present method can vary the stage precision by variably setting the magnification of the zoom lens 204 shown in FIG. 11 in correspondence to a high sensitivity specification and a high throughput specification of the device. Further, since it is possible to achieve the high-precision positional correction of the stage without using the laser length measuring device, it is possible to reduce a cost of the stage.

The present invention can be applied to any flat substrate without being limited to a glass substrate used for a liquid crystal panel, an ALTIC substrate, a sapphire substrate used for a sensor and an LED and the like, in addition to the embodiment of the foreign material inspecting device of the semiconductor substrate (wafer) in accordance with the manufacturing of the semiconductor.

Further, the present invention is not limited to the semiconductor inspecting device, but can be widely applied to various manufacturing steps of a hard disc, a liquid crystal panel display device, various sensors and the like.

It should be further understood by those skilled in the art that although the foregoing description has been made on embodiments of the invention, the invention is not limited thereto and various changes and modifications may be made without departing from the spirit of the invention and the scope of the appended claims.

1. An inspecting method of inspecting an inspected subject mounted on a moving stage by photographing by an image sensor, comprising the steps of:
determining a positional displacement amount between a target position and an actual position of said stage which moves; and
regulating and correcting a direction of said image sensor with respect to said inspected subject in correspondence to said positional displacement amount, in the photographing at said target position.

2. An inspecting device comprising:
a stage moving while mounting an inspected subject thereon; and
an image sensor photographing said inspected subject,
wherein the inspecting device comprises:
a memory portion storing an information indicating a positional displacement amount between a target position and an actual position of said stage which moves; and
a control portion regulating and correcting a direction of said image sensor with respect to said inspected subject on the basis of said information.

3. An inspecting method of inspecting an inspected subject mounted on a moving stage by photographing by an image sensor, comprising the steps of:
determining a positional displacement amount between a target position and an actual position of said stage which moves; and
carrying out a sampling position correction in correspondence to said positional displacement amount, on the basis of a photographed image sampling from a photographed range of said target position which is photographed.

4. An inspecting device comprising:
a stage moving while mounting an inspected subject thereon; and
an image sensor photographing said inspected subject,
wherein the inspecting device comprises:
a memory portion storing an information indicating a positional displacement amount between a target position and an actual position of said stage which moves; and
a processing portion sampling a photographed image by carrying out a sampling position correction in correspondence to said information, on the basis of a photographed image sampling from a photographed range of the photographed target position.

5. An inspecting method as claimed in claim 3, wherein the photographed range of said target position is larger than the sampled photographed image.

6. An inspecting method as claimed in claim 4, wherein the photographed range of said target position is larger than the sampled photographed image.

7. An inspecting method of photographing an inspected subject mounted on a stage moving vertically and horizontally in a coordinate of X-axis and Y-axis by an image sensor, comprising the steps of:
determining a positional displacement amount between a target position and an actual position of said stage which moves, on said coordinate;
regulating and correcting a direction of said image sensor with respect to said inspected subject in correspondence to said positional displacement amount corresponding one axis side on said coordinate; and
carrying out a sampling position correction in correspondence to said positional displacement amount corresponding to the other side axis on said coordinate, in an image sampling from a photographed range of the photographed target position.

8. An inspecting method of photographing an inspected subject mounted on a moving stage, and comparing and collating a photographed image, comprising the steps of:
individually determining a positional displacement amount between a target position and an actual position of said stage moving toward an individual image photographing; and
regulating and correcting a direction of said image sensor with respect to said inspected subject in correspondence to said positional displacement amount, in an image photographing at said individual target position.

9. An inspecting method of photographing an inspected subject mounted on a moving stage, and comparing and collating a photographed image, comprising the steps of:
individually determining a positional displacement amount between a target position and an actual position of said stage moving toward an individual image photographing; and
carrying out a sampling position correction in correspondence to each of said positional displacement amounts, in a photographed image sampling from a photographed range of each of said target positions.

10. An inspecting method of photographing an inspected subject mounted on a stage moving vertically and horizontally in a coordinate of X-axis and Y-axis by an image sensor, comprising the steps of:
determining a positional displacement amount between a target position and an actual position of said stage which moves, on said coordinate;
regulating and correcting a direction of said image sensor with respect to said inspected subject in correspondence to said positional displacement amount corresponding one axis side on said coordinate; and
regulating and correcting in correspondence to said positional displacement amount corresponding to the other side axis on said coordinate by said stage.

11. An inspecting method of photographing an inspected subject mounted on a stage moving vertically and horizontally in a coordinate of X-axis and Y-axis by an image sensor, comprising the steps of:
determining a positional displacement amount between a target position and an actual position of said stage which moves, on said coordinate;
regulating and correcting in correspondence to said positional displacement amount corresponding to one side axis on said coordinate, in a photographed image sampling from a photographed range of said photographed target position; and
regulating and correcting in correspondence to said positional displacement amount corresponding to the other side axis on said coordinate by said stage.

12. An inspecting method of photographing and inspecting an inspected subject mounted on a moving stage by an image sensor, comprising the steps of:
calculating a positional displacement amount between a target position and an actual position of said stage, on the basis of an image positional displacement amount between a reference image (801) and a comparative image (802) photographed by said image sensor.

13. An inspecting method as claimed in claim 12, wherein the method regulates and corrects in correspondence to said positional displacement amount in the movement of said stage.

14. An inspecting method as claimed in claim 12, wherein the method carries out a sampling position correction in correspondence to said positional displacement amount, in the photographed image sampling from the photographed range.

15. An inspecting method as claimed in claim 12, wherein the method corrects a position of the image sensor in correspondence to said positional displacement amount, in the photographing to be inspected.
